(19) United States
(12) Patent Application Publication
(10) Pub. No.: US 2025/0357565 A1
(43) Pub. Date: Nov. 20, 2025

(54) HYDROMETALLURGY PROCESS FOR RECYCLING LI-ION BATTERY MATERIALS

(71) Applicant: Khalifa University of Science and Technology, Abu Dhabi (AE)

(72) Inventors: Daniel CHOI, Abu Dhabi (AE); Kishore Kumar JENA, Abu Dhabi (AE)

(21) Appl. No.: 18/850,787

(22) PCT Filed: Oct. 13, 2023
(86) PCT No.: PCT/US23/76835

§ 371 Date: Sep. 25, 2024

(51) Int. Cl. H01M 10/54; C22B 3/00; C22B 3/08; C22B 3/22; C22B 26/12; C22B 47/00

(52) U.S. Cl. CPC H01M 10/54; C22B 3/08; C22B 3/22; C22B 23/043; C22B 26/12; C22B 47/00

(57) ABSTRACT

Methods of extracting one or more recyclable materials from a battery. The methods may include separating the battery into one or more battery components. The one or more battery components may include a cathode active material including the one or more recyclable materials. The methods may include drying the cathode active material. The methods may include heating the cathode active material. The methods may involve leaching the cathode active material to produce a leached cathode active material solution. The methods may involve extracting the one or more recyclable materials from the leached cathode active material solution.

### BACKGROUND

Lithium-ion batteries (LIBs) are energy storage systems that can be used in portable electronic devices and electric vehicles. Additionally, LIBs are considered to be significant power sources for electrical systems in aerospace as well as civilian applications. LIBs are widely used in portable electronics, such as mobile phone, laptop, camera, etc. and are expanding their market in the area of electric vehicles (EVs) and energy storage systems (ESS).

Lithium-ion batteries have grown popular due to their small sizes, high power densities, long cycle lives, high voltages, and low self-discharge rates. Due to limited resources, environmental issues, and strong demand for high energy densities in EVs, it may be desirable to recover valuable metals (Co, Li, Ni and Mn) from spent LIBs and recycle the materials to be used for production of the active materials as part of new LIBs. The materials recovered from recycling process with spent LIBs give benefits to make new batteries and could not only lower the manufacturing cost but also reducing carbon emission and helping to leave a sustainable environmental for the future.

### BRIEF SUMMARY OF THE INVENTION

Embodiments of the present technology may encompass methods of extracting one or more recyclable materials from a battery. The methods may include separating the battery into one or more battery components. The one or more battery components may include a cathode active material including the one or more recyclable materials. The methods may include drying the cathode active material. The methods may include heating the cathode active material. The methods may involve leaching the cathode active material to produce a leached cathode active material solution. The methods may involve extracting the one or more recyclable materials from the leached cathode active material solution.

In some embodiments, the methods may involve applying a mixture of one or more acids to the leached cathode active material solution to precipitate the leached cathode active material solution to separate the one or more recyclable materials from the leached cathode active material solution. The methods may involve vacuum filtering the leached cathode active material solution to remove contaminants from the leached cathode active material solution. The methods may involve applying deionized water to the leached cathode active material solution to further remove contaminants from the leached cathode active material solution. The methods may involve vacuum drying the leached cathode active material solution to remove additional contaminants from the leached cathode active material solution. Leaching the cathode active material can involve dissolving the cathode active material in an acidic solution. The acidic solution can include sulfuric acid (H₂SO₄) or citric acid (C₆H₈O₇). In some embodiments, the battery may be a lithium-ion battery. The recyclable materials comprise cobalt, lithium, nickel, manganese, or a combination thereof.

Embodiments of the present technology may encompass methods of extracting one or more recyclable materials from a cathode active material that has been extracted from a battery. The methods may involve leaching the cathode active material to produce a leached cathode active material solution. The methods may involve extracting the one or more recyclable materials from the leached cathode active material solution.

In some embodiments, the methods may involve applying a mixture of one or more acids to the leached cathode active material solution to precipitate the leached cathode active material solution to separate the one or more recyclable materials from the leached cathode active material solution. The methods may involve vacuum filtering the leached cathode active material solution to remove contaminants from the leached cathode active material solution. The methods may involve applying deionized water to the leached cathode active material solution to further remove contaminants from the leached cathode active material solution. The methods may involve vacuum drying the leached cathode active material solution to remove additional contaminants from the leached cathode active material solution. Leaching the cathode active material can involve dissolving the cathode active material in an acidic solution. The acidic solution can include sulfuric acid (H₂SO₄) or citric acid (C₆H₈O₇). In some embodiments, the battery may be a lithium-ion battery. The recyclable materials comprise cobalt, lithium, nickel, manganese, or a combination thereof.

### BRIEF DESCRIPTION OF DRAWINGS

FIG. 1 is a flow diagram of a process for recycling battery materials according to certain aspects of the present disclosure.

FIG. 2 is an illustration of an exemplary battery at various stages of disassembly during a pretreatment of the battery according to certain aspects of the present disclosure.

FIG. 3 is an illustration of exemplary disassembled components of a lithium-ion battery according to certain aspects of the present disclosure.

FIG. 4 is an illustration of an exemplary purification process for a battery active material according to certain aspects of the present disclosure.

FIGS. 5A and 5B an illustration of an exemplary battery active material according to aspects of the present disclosure.

FIG. 6 is an illustration of various stages of an exemplary leaching process and an exemplary precipitation process performed according to certain aspects of the present disclosure.

FIGS. 7A, 7B, and 7C are an illustration of various stages of an exemplary extraction process performed according to certain aspects of the present disclosure.

FIGS. 8A, 8B, and 8C are an illustration of exemplary resultant materials extracted from a thermal treatment process performed according to certain aspects of the present disclosure.

FIGS. 9A, 9B, and 9C are an illustration of exemplary x-ray diffraction data images of exemplary resultant materials according to certain aspects of the present disclosure.

### DETAILED DESCRIPTION

It may be desirable to retrieve materials, such as cobalt (Co), nickel (Ni), manganese (Mn), and lithium (Li), from spent lithium-ion batteries (LIBs). Materials recovered from recycling process of spent LIBs can be used to manufacture new batteries or other items. In many types of LIBs, the concentrations of Co and/or Ni metals, along with those of lithium (Li) and manganese (Mn), exceed the concentrations in natural ores. The LIBs may include an anode, a cathode, a separator between the anode and cathode, and an electrolyte. Enriched active electrode materials, such as active cathode materials or active anode materials, can be recovered from spent LIBs via a hydrometallurgical recycling process. In some examples, the spent LIBs can undergo shredding, sifting, thermal treatment, and solvent dissolving procedures in order to obtain the pure cathode active material. Then, recyclable materials, such as Co, Ni, Mn, and/or Li, can be extracted from the cathode active material. The recyclable materials extracted from the cathode active material can be used to manufacture new batteries.

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

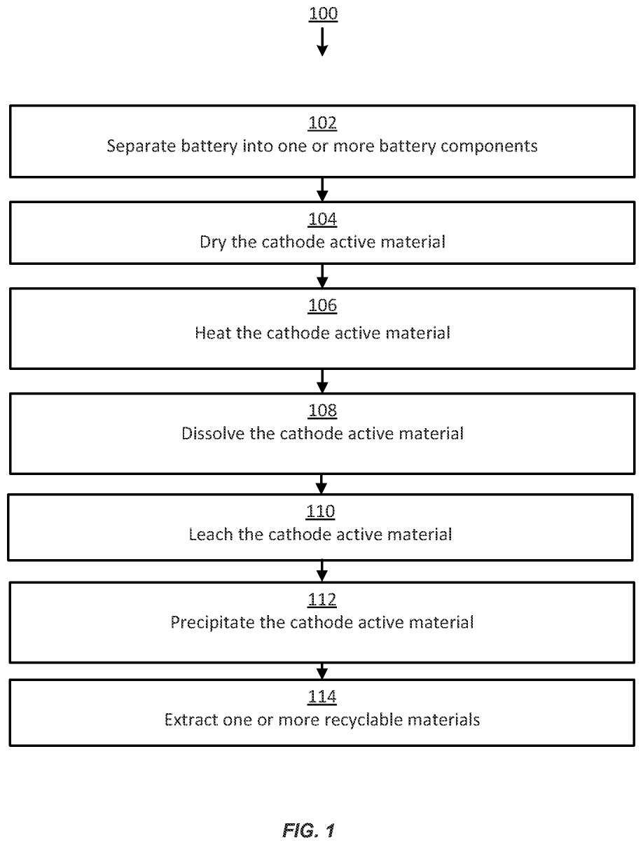

As illustrated in FIG. 1, a method 100 of extracting recyclable materials from a battery can involve pre-treating the battery at operation 102. Pre-treating the battery can involve dismantling the battery and separating the battery into its constituent battery components. In some examples, the battery components can include a casing, an anode, a cathode, a separator, and any other suitable battery components. One or more of the battery components, such as the cathode, can include a cathode active material of which the cathode may be composed. The cathode active material can include one or more recyclable materials. While the cathode active material is specifically discussed throughout, it is appreciated that other recyclable materials may be recovered from other battery components. As such, the present technology is not limited to recovering recyclable materials from cathode active materials.

Once the cathode active material has been separated from the other battery components, the cathode active material can be dried at operation 104. Additionally, the cathode active material can undergo a thermal treatment at operation 106. For example, the cathode active material can be heated in an oven or any other suitable heating device. The thermal treatment can be done to degrade polymer material and conductive carbon material. For example, the thermal treatment can begin at greater than or about 600° C., greater than or about 700° C., or greater than or about 800° C., or more, such as between 600° C. and 800° C. The thermal treatment can continue for greater than or about 4 hours, greater than or about 5 hours, or greater than or about 6 hours, or more, such as between about 4 and about 6 hours. Then, the cathode active material can be treated with a solvent, such as N-methylpyrrolidone (NMP), for solvent dissolution process. In embodiments, between about 10 and about 20 g of cathode active material can be treated in between about 80 and about 120 ml of solvent.

The cathode active material can be leached at operation 108 to produce a leached cathode active solution. The leached cathode active material solution can then be precipitated at operation 110 to separate the recyclable materials from the leached cathode active material solution. Once the precipitation reaction is complete, the recyclable materials can be extracted from the leached cathode active material solution.

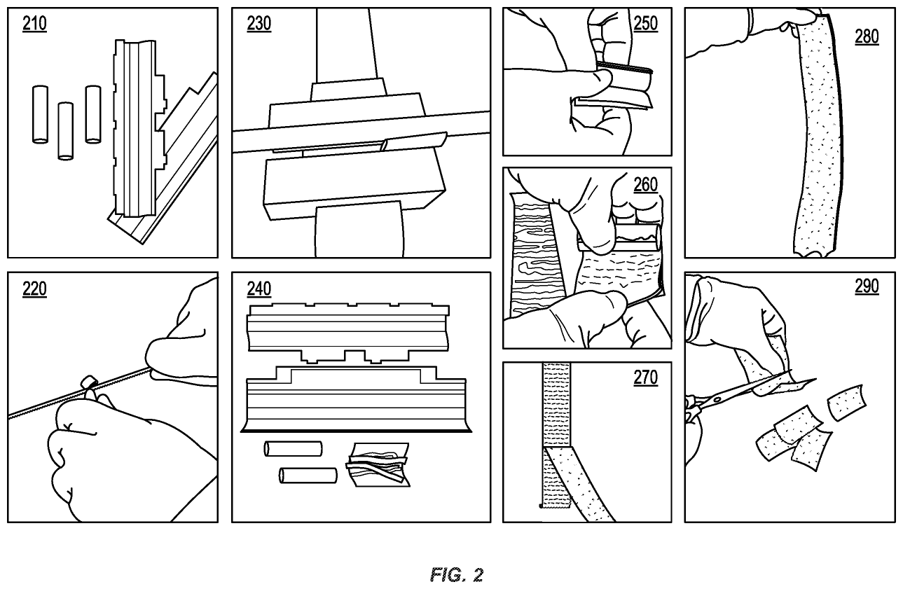

FIG. 2 is an illustration of a lithium-ion battery at various stages of disassembly during a pretreatment of the battery, such as during operation 102 of method 100, according to certain aspects of the present disclosure.

During the pretreatment, spent batteries can be dismantled to separate the batteries into one or more battery components. In some embodiments, plastic cases of the batteries can be removed followed by removing the steel case. The plastic cases can be dismantled manually using a table vise in order to extract cylindrical shape of the lithium-ion batteries, as shown in operations 210-240. The connected positive and negative terminals can be removed manually and then the cathode with the current collector can be separated, as shown in operation 250. The anode strip including the anode current collector (e.g., copper foil) coated with graphite anode active materials and binders may be separated, as shown in operation 260. In some examples, the electrolyte strip may be separated, as shown in operation 270. The cathode strip including an aluminum foil coated with cathode active materials and/or binders from single cylindrical battery can be separated, as shown in operation 280. At operation 290, the cathode strip can be cut into pieces for subsequent chemical processes.

To avoid short-circuiting and self-ignition during the dismantling, the spent batteries can be discharged. For example, the battery can be submerged in a NaCl solution. The solution may be less than or about 4 wt. % NaCl solution, less than or about 3 wt. % NaCl solution, or less than or about 2 wt. % NaCl solution, or less, such as between about 2 wt. % and about 4 wt. % NaCl solution. The battery can be submerged in the NaCl solution for less than or about 30 hours, less than or about 20 hours, or less than or about 10 hours, or less, such as between about 10 hours and about 30 hours in order to discharge the battery.

FIG. 3 is an illustration of disassembled battery components of a lithium-ion battery according to certain aspects of the present disclosure. Depending on the construction of the batteries, the spent batteries can be uncurled and separated into, for example, metal cases 310 (e.g. stainless steel metal cases), plastic separators 320 (e.g. polypropylene-based separator strips), anodes 330, and cathodes 340.

After the pretreatment and separation of battery materials, during a thermal treatment operation, the cathodes can be dried for less than or about 30 hours, such as less than or about 20 hours, less than or about 10 hours, or less, such as between about 10 hours and about 30 hours. A temperature during the thermal treatment may be at less than or about 150° C., and may be less than or about 140° C., less than or about 130° C., less than or about 120° C., less than or about 110° C., less than or about 100° C., less than or about 90° C., or less, such as between about 90° C. and about 150° C. Afterward, the cathode materials can be cut into small pieces (for example, pieces between about 2 and about 4 square centimeters in size) and baked in a muffle furnace to burn off organic binders. The cathode materials may be baked at a temperature greater than or about 750° C., greater than or about 775° C., greater than or about 800° C., greater than or about 825° C., or more, such as at a temperature between about 750° C. and about 850° C. To ensure adequate removal of the organic binders, the cathode materials may be baked for greater than or about 3 hours, greater than or about 4 hours, greater than or about 5 hours, greater than or about 6 hours, or greater than or about 7 hours, or more, such as between about 3 hours and about 5 hours. The temperature during the baking may increase at a ramp of greater than or about 4° C./min, greater than or about 5° C./min, or greater than or about 6° C./min, or more, such as between about 4° C./min and about 6° C./min.

In some examples, applying a thermal treatment, such as operation 106, before solvent dissolution process, such as operation 108, can reduce the solvent consumption during the recycling process and increase the environmental safety of the solvent dissolution process. Most of the polymer and conducting materials can be removed from the electrode materials during heat treatment. Therefore, less solvent can be required to process for the solvent dissolution process. In some examples, the same solvent can be used several times, which can be cost effective. For example, the solvent can be reused greater than or about 5 times, greater than or about 10 times, or greater than or about 15 times, or more, such as between about 5 times and about 15 times, for dissolution process. This is possible due to the presence of negligible amounts of polymer and conductive materials in thermally treated active cathode material. In some examples, greater than or about 180 g, greater than or about 200 g, or greater than or about 220 g, or more, such as between about 180 g and about 200 g of active cathode material can be recovered by using 90 ml or less, 100 ml or less, or 110 ml or less of solvent, such as NMP, or any other suitable solvent.

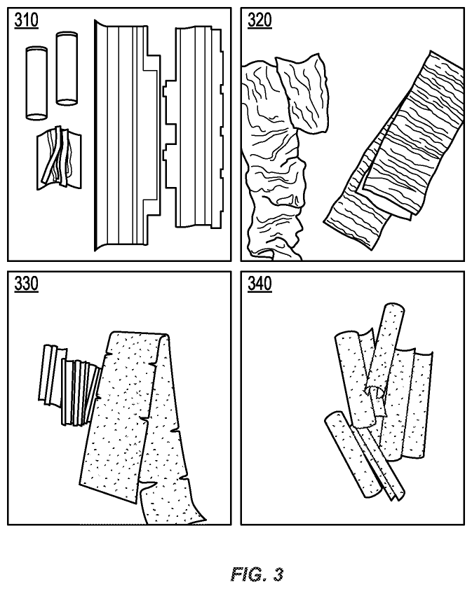

FIG. 4 is an illustration of an exemplary purification process, such as operation 106 for a cathode active material according to certain aspects of the present disclosure. In some examples, a cathode can include the cathode active material as well as a variety of impurities. Purifying the cathode active material can remove the impurities and allow for more efficient recycling of the cathode active material. In some examples, purifying the cathode active material can involve applying a solvent to the cathode active material. Additionally, purifying the cathode active material can involve filtering impurities from the cathode active material.

At operation 410, during the solvent dissolution operation, such as operation 108 the baked active cathode material can be transferred to a round bottom flask and combined with a solvent. In embodiments, the solvent may be or include NMP. Other organic liquids, such as ethanol, methanol, dimethylformamide (DMF), or toluene can be used as solvents in the solvent dissolution process. However, NMP may provide a higher recovery rate than other solvents.

The solvent dissolution operation can be carried out at greater than or about 180° C., greater than or about 190° C., greater than or about 200° C., or more, such as between about 180 and about 200. The solvent dissolution operation can continue for greater than or about 12 hours, greater than or about 24 or more hours, greater than or about 48, or more, such as between about 12 hours and about 48 hours. In some examples, the solvent can be reused in additional dissolution processes due to low levels of polymeric material and/or conducting materials in thermally treated cathode active material. To prevent solvent evaporation during the dissolving process, a reflux setup with a constant water flow can be implemented. Additionally, a slight swirling motion can be applied to maintain a uniform temperature distribution during the dissolution process.

At operations 420-460, after the dissolution process, aluminum can be removed from the solution by applying additional solvent, such as additional amounts of NMP or another useful solvent. A plastic pipette can be used at operations 430 and 440 to transfer the dispersed cathode materials solution to a filter cup for filtering as shown in operation 450. The dispersed cathode active material can be filtered via a vacuum filtration process. The filtered cathode active material powder can be dried in an oven. For example, the filtered cathode active material powder can be dried at roughly any of the ranges previously discussed, such as between about 100° C. and about 140° C. for any of the durations previously discussed, such as about 24 hours, and then again at between about 160° C. and about 200° C. for 4 hours. In some examples, the dispersed cathode active material can be air-dried at operations 460 and 470.

At operation 470, the cathode active material can be finely ground to produce fine particles that are suitable for leaching. In some examples, the cathode active material powder can be ground manually via a mortar and pestle, although any techniques for grinding the cathode active material powder may be used.

At operation 480, the finely ground cathode active material powder can be stored in a container.

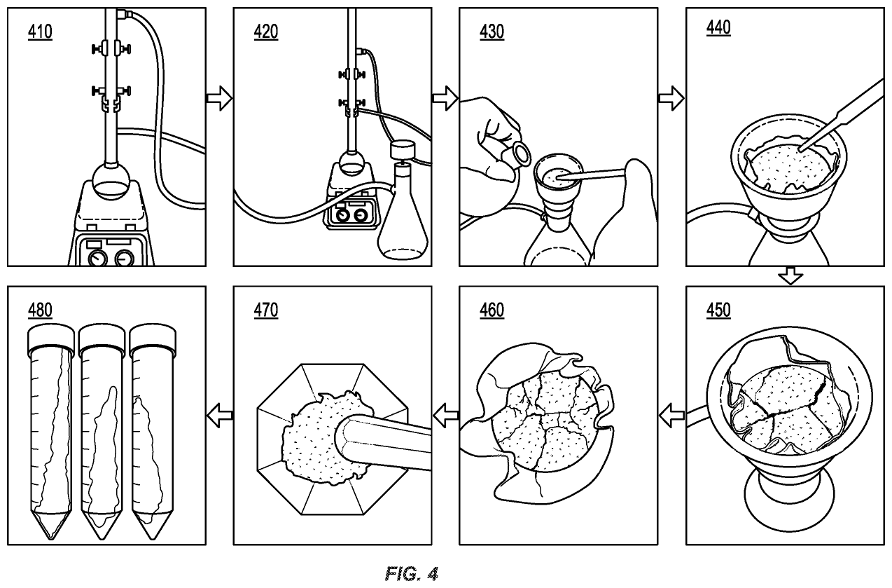

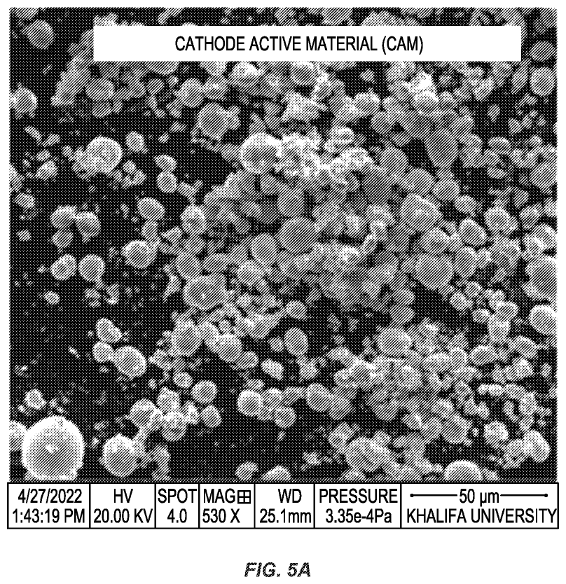

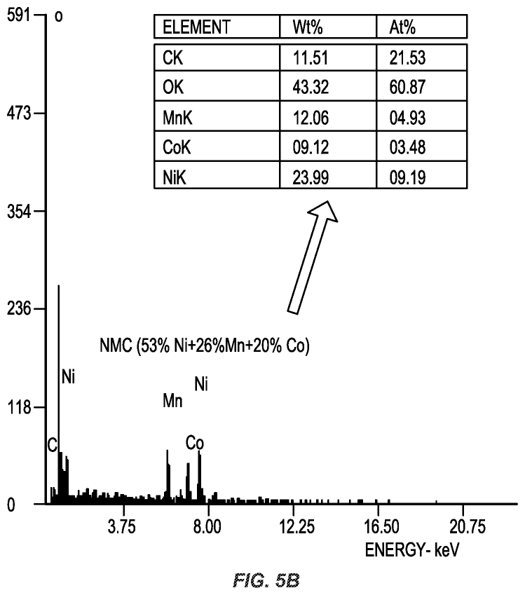

FIG. 5 is an illustration of an exemplary cathode active material according to aspects of the present disclosure. FIG. 5A may depict an exemplary electron microscope image of the cathode active material. FIG. 5B may depict exemplary x-ray diffractometry data associated with the cathode active material. The data from the above analysis techniques can be used to determine the composition of the recycled cathode active material.

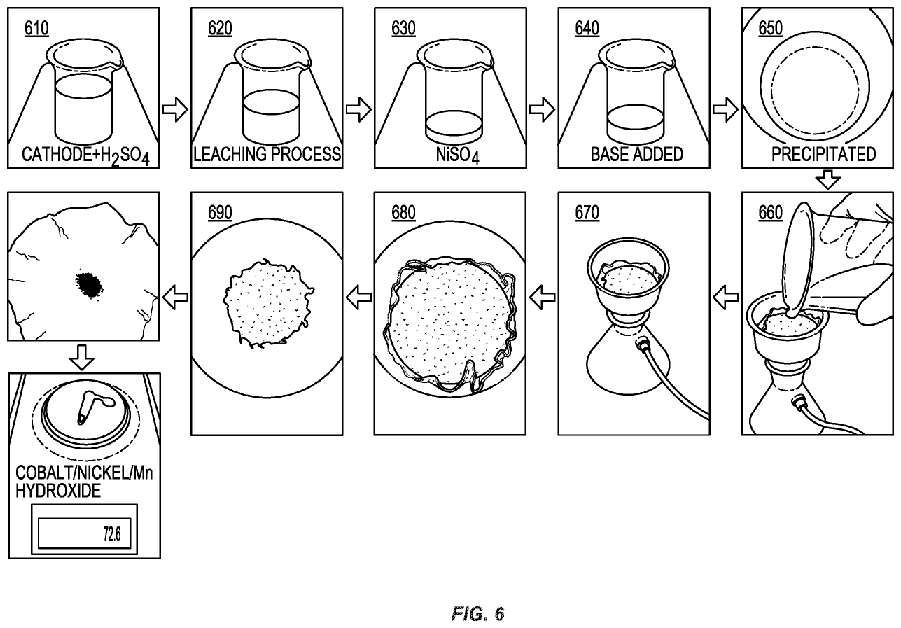

FIG. 6 is an illustration of various stages of a leaching process, such as operation 110, and a precipitation process, such as operation 112. After the solvent dissolution process, a leaching process can be carried out using inorganic and organic acids, such as sulfuric acid (H₂SO₄) and citric acid (C₆H₈O₇). Various molar concentrations of the inorganic and organic acids, various temperatures, various reducing agent concentrations, and various solid to liquid (S/L) ratios can be used to tune the leaching process. To retrieve recyclable materials, such as metals, from the leachate solution, the recyclable materials can be treated with a basic solution, such as a reducing agent, that can yield one or more metal hydroxides. A subsequent heat treatment may then convert may convert the metal hydroxides to metal oxides. The heat treatment may be performed at a higher temperature than the treatment with the basic solution. The heat treatment may be performed under inert environment. The reducing agent, such as hydrogen peroxide (H₂O₂), concentration can be greater than or about 1 vol. %, greater than or about 2 vol. %, or greater than or about 4.0 vol. %, or more, such as between about 1 vol. % and about 4 vol. %. The reaction time may be between about 1 hour and about 24 hours depending on the reaction conditions.

In some examples, a hydrometallurgical process, such as the leaching process, can be used to recycle the active materials from spent LIBs. Organic and/or inorganic acids can be used for acid-based leaching processes. Inorganic acids, such as H₂SO₄, can be strong acids which can facilitate fast leaching reactions and give high recovery rates of metals from spent LIBs. H₂SO₄ can be less costly than certain organic acids, but there may be concerns with the environmental impact of H₂SO₄. Therefore, organic acids, such as C₆H_{d}O₇, can be also used as a leaching agent. The recovery percentage can be similar for both organic acids and inorganic acid.

At operation 610, the cathode active material may be mixed with an acid. The acid can be an organic acid, such as C₆H₈O₇, an inorganic acid, such as H₂SO₄, a combination thereof, or any other suitable acid. The cathode active material can be introduced to the acid in a glass reactor, or any other suitable reaction vessel.

At operation 620, the cathode active material begins leaching into the acid to form a leached cathode active material solution. In some examples, the cathode active material and acid may be stirred during the reaction. In some examples, the cathode active material and acid may be kept at a constant temperature and/or pressure during the reaction.

At operation 630, the leaching is complete, and the cathode active material and the acid can form a leached cathode active material solution.

At operation 640, a base can be introduced to the leached cathode active material solution to begin a precipitation reaction. In some examples, co-precipitation can be used to recover the Co, Ni, Mn, and Li from the H₂SO₄ and/or C₆H₈O₇+H₂O₂ leachate. In a glass reactor containing the H₂SO₄ and/or C₆H₈O₇+H₂O₂ leachate, solutions of about sodium hydroxide (NaOH) and ammonium hydroxide (NH₄OH) can be added. In embodiments, the molarity of the NaOH may be greater than or about 3.0 M, greater than or about 4.0 M, greater than or about 5.0 M. or more, such as between about 3.0 M and about 5.0 M. The molarity of the NH₄OH may be greater than or about 0.2 M, greater than or about 0.3 M, greater than or about 0.4 M, greater than or about 0.5 M, greater than or about 0.6 M, or more, such as between about 0.2 M and about 0.6 M. The NaOH and NH₄OH may be separately pumped until the pH is greater than or about 10, greater than or about 10.2, greater than or about 10.4, greater than or about 10.6, greater than or about 10.8, greater than or about 11, or more. The pH of the solution can be monitored by a pH meter. To allow for the complete precipitation of the target components, the mixture can be kept at a constant temperature (such as 50° C.) for a predetermined amount of time (such as 24 hours under) constant stirring (such as at 800 rpm) in an inert gas environment, such as an argon environment. The precipitated product can be then vacuum-filtered, cleaned of contaminants and alkalinity using deionized water, and vacuum-dried for 24 hours at 100° C. to produce Co, Ni, and Mn coprecipitate. Li filtrate solution with a pH above 11 can be concentrated by water evaporation and then precipitated as lithium carbonate (Li₂CO₃) with a saturated sodium carbonate (Na₂CO₃) solution at 95° C. Individual metal oxide can be recovered by changing the pH.

At operation 650, the precipitation reaction may be complete, and the recyclable materials may be separate from the leached cathode active material solution. As previously discussed, the recyclable materials can include Co, Li, Ni, Mn, or a combination thereof. Once the recyclable materials have been separated from the leached cathode active material solution, the recyclable materials can be extracted from the reactor.

At operation 660, the precipitated solution can be transferred to a filter cup. At operation 670, the precipitated solution may be collected using vacuum filtration. At operations 680 and 690, precipitate-filled filter paper may be baked. The precipitate can be removed from the filter paper and placed in a container after drying.

In embodiments, the leached cathode active material solution can be vacuum filtered to remove impurities. The leached cathode active material solution can also be cleaned with deionized (DI) water and vacuum dried to further remove impurities.

Acid mole concentration, temperature. H₂O₂ concentration, and/or S/L ratio can influence the extraction of Co, Ni, and Mn, while they can show negligible effects on the leaching of Li. The recovered cathode active materials can be leached using a H₂SO₄C₆H₈O₇ solution. The H₂SO₄/C₆H₈O₇ may be characterized by a molarity of greater than or about 1.0 M, greater than or about 2.0 M, greater than or about 3.0 M, greater than or about 4.0 M, or greater than or about 5.0 M, or more, such as between about 1.0 M and about 5.0 M. The H₂SO₄C₆H₈O₇ can be prepared as stock solution, and then about 50% H₂SO₄ and about 50% C₆H₈O₇ can be taken for the leaching process.

In embodiments, a temperature during the leaching temperature may be greater than or about 30° C. greater than or about 40° C., greater than or about 50° C., greater than or about 60° C., greater than or about 70° C., greater than or about 80° C., greater than or about 90° C., or more, such as between about 30° C. and about 90° C. The S/L ratio may be greater than or about 20 g/l, greater than or about 30 g/l, greater than or about 40 g/l, greater than or about 50 g/l, or more, such as between about 20 g/l and about 50 g/l, be from 20 g/l or more, 30 g/l or more, or 40 g/I or more. In an exemplary embodiment, the leaching reaction solution can be prepared using 3.0 M H₂SO₄/3.0 M C₆H₈O₇, 1.6 vol. % H₂O₂, and a S/L ratio of 20 g/l while maintaining leaching process at 90° C. for 40 min.

Co-precipitation can be used to recover the Co, Ni, Mn, and Li from the H₂SO₄/C₆H₈O₇ and H₂O₂ leachate. In a glass reactor containing the H₂SO₄/C₆H₈O₇ and H₂O₂ leachate, solutions of NaOH and NH₄OH can be separately pumped until the pH is greater than or about 10, greater than or about 10.2, greater than or about 10.4, greater than or about 10.6, greater than or about 10.8, greater than or about 11, or more as previously discussed. Also as previously discussed, in embodiments, the NaOH solution may be characterized by a molarity of greater than or about 1.0 M, greater than or about 2.0 M, greater than or about 3.0 M, greater than or about 4.0 M, greater than or about 5.0 M, or more, such as between about 1.0 M and about 5.0 M. Similarly, the NH₄OH may be characterized by a molarity of greater than or about 0.2 M, greater than or about 0.3 M, greater than or about 0.4 M, greater than or about 0.5 M, greater than or about 0.6 M, greater than or about 0.7 M, greater than or about 0.8 M. or more, such as between about 0.2 M and about 0.8 M. The pH of the solution can be monitored by a pH meter. To allow for the complete precipitation of the target components, the mixture can be kept at about 50° C. for 24 hours under constant stirring at about 600 rpm to about 1000 rpm in an inert environment, such as an argon environment. The precipitated product can be then vacuum filtered, cleaned of contaminants and alkalinity using deionized water, and vacuum dried for between about 12 hours and about 48 hours, such as about 24 hours, 12-48 hours at about 100° C. to produce Co, Ni, and Mn coprecipitate. Li in the filtrate solution can be concentrated by water evaporation and then precipitated as lithium carbonate (Li₂CO₃) with a saturated sodium carbonate (Na₂CO₃) solution at about 95° C. Individual metal oxide can be recovered by changing the pH. In an exemplary embodiment, the co-precipitation reaction can be conducted using a mixture of 3.0-5.0 M NaOH and 0.2-0.6 M NH₄OH, and 4.0-5.0 M NaOH. Through the present technology, it is possible to observe high reaction yields of greater than or about 98% for Co (e.g., 98.1%), greater than or about 99% for Li (e.g., 99.7%), greater than or about 99% for Ni (e.g., 99.6%), and greater than or about 98% for Mn (e.g., 98.7%).

Table 1 summarizes recyclable material recovery percentages by using various inorganic acid leaching processes including differing S/L ratios, H₂O₂ concentrations, and temperatures.

TABLE 1

| | Temperature:S/L | Metal | Total Metal % | H₂O₂ concentration:Recovery | S/L | Temp |
|---|---|---|---|---|---|---|
| H₂SO₄ | ratio | recovered | recovered | percentage | ratio | (° C.) |
| 5M | 50:20 | | 37.88% | | | |
| 3M | 50 | Ni = 102.6 mg | [symbol] | 0.2:41.12% | [symbol] | 30:44.11% |
| | | Mn = 56.7 mg | | 0.4:42.16% | 30:42.19 | 40:43.89% |
| | | Co = 28.6 mg | | 0.6:42.09% | 40:42.07% | 50:44.56% |
| | | | | 0.8:42.98% | 50:36.89% | 70:45.88% |
| | | | | 1.0:43.87% | | 80:47.21% |
| | | | | [symbol] | | [symbol] |
| | | | | 1.6:43.99% | | |
| | | | | 1.8:43.11% | | |
| | | | | 2.0:42.78% | | |
| 2M | 50 | Ni = 98.7 mg | [symbol] | 0.2:35.65% | [symbol] | 30:34.12% |
| | | Mn = 46.5 mg | | 0.4:39.25% | 30:34.32% | 40:36.72% |
| | | Co = 21.9 mg | | 0.6:39.89% | 40:34.02% | 50:33.42% |
| | | | | 0.8:40.11% | 50:33.77% | 70:35.99% |
| | | | | 1.0:41.32% | | 80:41.22% |
| | | | | [symbol] | | [symbol] |
| | | | | [symbol] | | |
| | | | | [symbol] | | |
| | | | | 2.0:42.99% | | |
| 1M | 50 | | 27.32% | | | |

[symbol]

indicates data missing or illegible when filed

Table 2 summarizes recyclable material recovery percentages by using various organic ac id leaching processes including differing S/L ratios, H₂O₂ concentrations, and temperatures.

TABLE 2

| | | | H₂O₂ | | |
|---|---|---|---|---|---|
| | Temper- | Total | concentra- | | |
| Citric | ature:S/L | Metal % | tion:Recovery | S/L | Temp |
| acid | ratio | recovered | percentage | ratio | (° C.) |
| 5M | 50:20 | 37.06% | | | |
| 3M | 50 | 39.96% | 0.2:40.11% | 20:44.29% | 30:41.21% |
| | | | 0.4:40.06% | 30:41.99% | 40:43.55% |
| | | | 0.6:42.19% | 40:40.17% | 50:44.29% |
| | | | 0.8:41.88% | 50:34.19% | 70:44.89% |
| | | | 1.0:42.23% | | 80:51.02% |
| | | | 1.4:43.96% | | 90:53.77% |
| | | | 1.6:44.29% | | |
| | | | 1.8:44.01% | | |
| | | | 2.0:42.38% | | |
| 2M | 50 | 36.02% | 0.2:36.15% | 20:42.16% | 30:37.33% |
| | | | 0.4:35.23% | 30:39.02% | 40:38.22% |
| | | | 0.6:38.19% | 40:38.62% | 50:42.16% |
| | | | 0.8:41.01% | 50:36.79% | 70:42.78% |
| | | | 1.0:41.22% | | 80:49.87% |
| | | | 1.4:41.96% | | 90:50.75% |
| | | | 1.6:42.16% | | |
| | | | 1.8:44.13% | | |
| | | | 2.0:42.99% | | |
| 1M | 50 | 31.09% | | | |

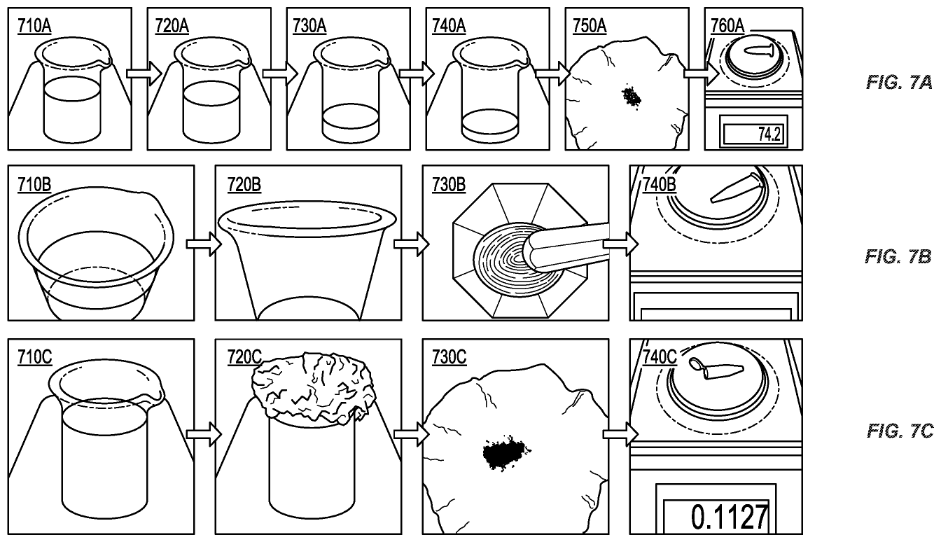

FIGS. 7A-C are illustrations of various stages of an extraction process performed according to certain aspects of the present disclosure. FIG. 7A includes illustrations of a process for recovering a nickel hydroxide from a cathode active material. FIG. 7B includes illustrations of a process for recovering manganese hydroxide from a cathode active material. FIG. 7C includes illustrations of a process for recovering cobalt hydroxide from a cathode active material.

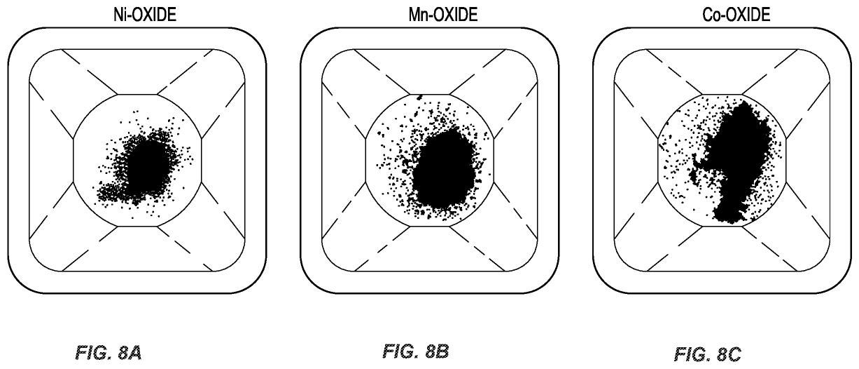

FIGS. 8A-C are illustrations of exemplary resultant materials extracted from a thermal treatment process performed according to certain aspects of the present disclosure. The resultant materials can include oxides of nickel, manganese, and cobalt as shown in FIG. 8A, FIG. 8B, and FIG. 8C, respectively. The resultant materials can be stored in containers prior to use as recyclable materials in further applications.

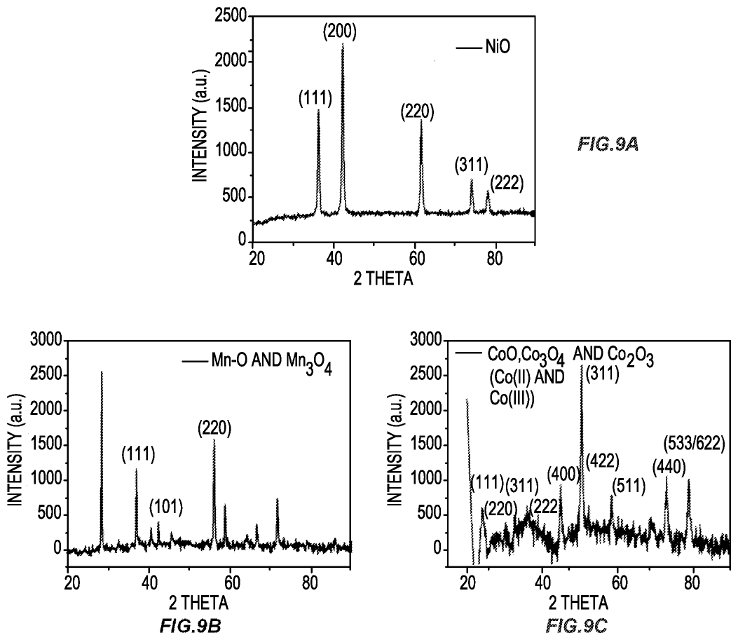

FIGS. 9A-C are illustrations of exemplary x-ray diffraction data images of exemplary resultant materials according to certain aspects of the present disclosure. The morphology and structure of recyclable materials can be investigated by X-ray diffraction (XRD) and scanning electron microscope (SEM). This method can be carried out with an eye toward cost-effectiveness, environmental protection, and industrial considerations. The crystal structure of nickel, manganese and cobalt oxides can be determined via X-ray diffraction (XRD) analysis and reported in FIG. 9A, FIG. 9B, and FIG. 9C, respectively. The observed peaks for nickel, manganese and cobalt oxide confirm that the recyclable materials have maintained structure regularities without loss of crystallinity.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

While the disclosed techniques can be susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it can be individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure, and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y. or Z, or any combination thereof (e.g., X, Y. and/or Z). Thus, such disjunctive language is not generally intended to, and should not, imply that certain embodiments require at least one of X, at least one of Y, or at least one of Z to each be present.

What is claimed is:

1. A method of extracting one or more recyclable materials from a battery, the method comprising:
separating the battery into one or more battery components, wherein the one or more battery components comprise a cathode active material including the one or more recyclable materials;
drying the cathode active material;
heating the cathode active material;
leaching the cathode active material to produce a leached cathode active material solution; and
extracting the one or more recyclable materials from the leached cathode active material solution.

2. The method of claim 1, further comprising:
applying a mixture of one or more acids to the leached cathode active material solution to precipitate the leached cathode active material solution to separate the one or more recyclable materials from the leached cathode active material solution.

3. The method of claim 2, further comprising:
vacuum filtering the leached cathode active material solution to remove contaminants from the leached cathode active material solution.

4. The method of claim 3, further comprising:
applying deionized water to the leached cathode active material solution to further remove contaminants from the leached cathode active material solution.

5. The method of claim 4, further comprising:
vacuum drying the leached cathode active material solution to remove additional contaminants from the leached cathode active material solution.

6. The method of claim 1, wherein leaching the cathode active material comprises dissolving the cathode active material in an acidic solution.

7. The method of claim 6, wherein the acidic solution comprises sulfuric acid (H₂SO₄) or citric acid (C₆H₈O₇).

8. The method of claim 1, wherein the battery comprises a lithium-ion battery.

9. The method of claim 1, wherein the recyclable materials comprise cobalt, lithium, nickel, manganese, or a combination thereof.

10. The method of claim 1, further comprising:
stirring the leached cathode active material solution to prevent the leached cathode active material solution from settling; and
heating the leached cathode active material solution to maintain a constant temperature of the leached cathode active material solution.

11. A method of extracting one or more recyclable materials from a cathode active material that has been extracted from a battery, the method comprising:
leaching a cathode active material to produce a leached cathode active material solution; and
extracting one or more recyclable materials from the leached cathode active material solution.

12. The method of claim 11, further comprising:
applying a mixture of one or more acids to the leached cathode active material solution to precipitate the leached cathode active material solution to separate the one or more recyclable materials from the leached cathode active material solution.

13. The method of claim 12, further comprising:
vacuum filtering the leached cathode active material solution to remove contaminants from the leached cathode active material solution.

14. The method of claim 11, further comprising:
applying deionized water to the leached cathode active material solution to remove contaminants from the leached cathode active material solution.

15. The method of claim 14, further comprising:
vacuum drying the leached cathode active material solution to remove additional contaminants from the leached cathode active material solution.

16. The method of claim 11, wherein leaching the cathode active material comprises dissolving the cathode active material in an acidic solution.

17. The method of claim 16, wherein the acidic solution comprises sulfuric acid (H₂SO₄) or citric acid (C₆H₈O₇).

18. The method of claim 11, wherein the battery comprises a lithium-ion battery.

19. The method of claim 11, wherein the recyclable materials comprise cobalt, lithium, nickel, manganese, or a combination thereof.

20. The method of claim 11, further comprising:
stirring the leached cathode active material solution to prevent the leached cathode active material solution from settling; and
heating the leached cathode active material solution to maintain a constant temperature of the leached cathode active material solution.
